(19) United States
(12) Patent Application Publication
(10) Pub. No.: US 2004/0070503 A1
(43) Pub. Date: Apr. 15, 2004

(54) Flexible RFID antenna panel and system

(76) Inventor: Brian Monahan, Santa Cruz, CA (US)

Correspondence Address: Ralph C. Francis, Francis Law Group, 1808 Santa Clara Avenue, Alameda, CA, 94501, US

(21) Appl. No.: 10/269,716

(22) Filed: Oct. 10, 2002

(51) Int. Cl. G08B 13/14

(52) U.S. Cl. 340/572.7

(57) ABSTRACT

A RFID antenna system for communicating with at least one transponder disposed on an object (e.g., product carrier, product, etc.) moveable along an interrogation path comprising at least one antenna panel that defines an antenna region, the antenna panel including at least one substantially continuous antenna loop for transmitting and receiving electromagnetic fields, the antenna panel being oriented such that the antenna panel intersects the interrogation path. The antenna panel can be substantially flexible or rigid.

### FIELD OF THE INVENTION

The present invention relates in general to radio frequency identification (RFID) devices. More particularly, the invention relates to a flexible RFID antenna panel and system.

### BACKGROUND OF THE INVENTION

RFID systems are well known in the art. Such systems include relatively large packages containing battery powered transmission/receiving circuitry, such as the identification system disclosed in U.S. Pat. No. 4,274,083, to passive systems in which the transponder receives its power from the base station or interrogator, such as the identification system disclosed in U.S. Pat. No. 4,654,658.

A typical RFID system is made up of reusable transponders or tags fixed to or embedded in product carriers, an antenna system that interrogates the tags via a RF link and a controller. The host (or computer) system interfaces with the controller and directs the interrogation of the tags.

The RFID antenna system typically employs a high frequency signal to interrogate the tags and, hence, product carriers that are moved on an interrogation path, such as a conveyor. The antenna system is generally disposed near the interrogation path to provide effective communication to and from the tags.

The location of the antenna is critical to the interrogation and receipt of the identification code and other data transmitted to and from the tags. For example, if a relatively small single antenna is employed or the antenna is positioned too far from the interrogation path, inadequate coverage of the interrogation path will occur.

Several attempts have been made to optimize the RF link and, hence, communication between the antenna and the tags. In one (typically employed) approach, a frame antenna of rectangular or square shape is fitted around the conveyor.

The noted system has several drawbacks. In particular, the antenna system exhibits one or more dead zones for certain tag positions. For example, there is a dead zone across the very center of the conventional frame antenna. If a tag is located within a window that is parallel to the conveyor belt and comprises some distance on either side of the center frame axis, and maintains this position throughout the read area of the antenna, the tag would not be read.

Moreover, the accuracy and completeness of the reading also decreases if several tags are following one another in close succession during movement along the conveyor. When tags are in close succession and relatively far from the read antenna, the tags appear to be the same distance from the read antenna and thus send back simultaneous transmissions. The result of a simultaneous transmission is an unintelligible identification code. This is particularly the case in a noisy environment, for which shielding would be necessary.

It is therefore an object of the present invention to provide a RFID antenna panel and system that overcomes the noted drawbacks associated with prior art antenna systems.

It is another object of the invention to provide an antenna system having at least one antenna panel that provides optimum coverage over the interrogation path.

It is another object of the present invention to provide a RFID antenna system that can be readily incorporated into a conveyor system to provide accurate interrogation of tags fixed to or embedded in product carriers.

It is another object of the present invention to provide a RFID antenna system that can be readily incorporated into the entrance to a building or warehouse (e.g., dock door) to provide accurate interrogation of tags fixed to or embedded in product carriers passing through the entrance.

It is yet another object of the present invention to provide a RFID antenna system that can be readily incorporated into cargo trucks or trailers to provide accurate interrogation of tags disposed on products or product carriers during loading and unloading.

### SUMMARY OF THE INVENTION

In accordance with the objects and advantages of the present invention, the RFID antenna system for communicating with at least one transponder disposed on an object (e.g., product carrier, product, etc.) moveable along an interrogation path generally comprises at least one flexible antenna panel, the antenna panel defining an antenna region, the antenna panel including at least one substantially continuous antenna loop for transmitting and receiving electromagnetic fields, the antenna panel being oriented such that the antenna panel intersects the interrogation path, the antenna panel being adapted to bend about at least a first axis when the object intersects the antenna region. The antenna panel is preferably substantially planar and rectangular in shape.

In an additional embodiment of the invention, the antenna system comprises at least one substantially rigid antenna panel that similarly defines an antenna region, the antenna panel including at least one substantially continuous antenna loop for transmitting and receiving electromagnetic fields, the antenna panel being oriented such that the antenna panel intersects the interrogation path, the antenna panel being hingedly connected to at least a first hinge connection whereby the antenna panel rotates about the hinge connection when an object intersects the antenna region.

In an additional embodiment of the invention, the antenna system includes a support member; at least one antenna panel, the antenna panel defining an antenna region, the antenna panel including at least one substantially continuous antenna loop for transmitting at least a first electromagnetic field and receiving at least a second electromagnetic field, the antenna panel being attached to the support member such that the antenna panel intersects the interrogation path; and control means in communication with the antenna loop for controlling said transmittal and receipt of the first and second electromagnetic fields by the antenna loop.

In one aspect of the noted embodiment, the antenna panel is substantially flexible and adapted to bend about at least a first axis when the object intersects the antenna region. In a further aspect of the invention, the antenna panel is substantially rigid and the support member includes at least one hinge connection that is adapted to hingedly engage the antenna panel, the antenna panel being adapted to rotate about the hinge connection when the object intersects the antenna region.

In a further embodiment of the invention, the antenna system includes a conveyor system adapted to transport at least one of the objects along the interrogation path.

In an additional embodiment, the antenna system includes a conveyor antenna disposed proximate the interrogation path. The conveyor antenna is adapted to transmit at least a third electromagnetic field and receive at least a fourth electromagnetic field, the third and fourth electromagnetic fields being directed substantially perpendicular to the interrogation path.

In yet another embodiment of the invention, the antenna system comprises a support system having a first substantially vertical support member and a second substantially vertical support member; first and second antenna panels, the first antenna panel including at least a first substantially continuous antenna loop for transmitting at least a first electromagnetic field and receiving at least a second electromagnetic field, the second antenna panel including at least a second substantially continuous antenna loop for transmitting at least a third electromagnetic field and receiving at least a fourth electromagnetic field; the first and second antenna panels being substantially rectangular in shape and including first and second vertical edge regions, the first antenna panel first vertical region being engaged to the first vertical support member and the second antenna first vertical region being engaged to the second vertical support member, whereby the first and second antenna panels define an antenna region, the antenna region intersecting the interrogation path.

In one aspect of the noted embodiment, the first and second antenna panels are substantially flexible. The first flexible antenna panel is rigidly engaged to the first vertical support member and the second flexible antenna panel is rigidly engaged to the second vertical support member, the first flexible antenna panel being adapted to bend about at least a first axis when an object intersects the antenna region and the second flexible antenna panel being adapted to bend about at least a second axis when an object intersects the antenna region.

In a further aspect of the invention, the first and second antenna panels are substantially rigid. The first rigid antenna panel is hingedly connected to the first vertical support member and the second rigid antenna panel is hingedly connected to the second vertical support member, the first and second rigid antenna panels being adapted to rotate about the hinge connections when an object intersects the antenna region.

In a further aspect of the noted embodiment, the antenna system similarly includes a conveyor antenna disposed proximate the interrogation path, the conveyor antenna being adapted to transmit at least a fifth electromagnetic field and receive at least a sixth electromagnetic field, the fifth and sixth electromagnetic fields intersecting the interrogation path.

In a further embodiment of the invention, the RFID antenna system comprises at least one antenna panel system (as described herein) disposed in the entrance to a building, the antenna panel, if flexible, being adapted to bend about a first axis when an object passes through the building entrance or, if rigid, rotate about a hinge connection when an object passes through the building entrance.

In yet a further embodiment of the invention, the RFID antenna system comprises at least one antenna panel system (as described herein) disposed in the entrance to a transport vehicle (e.g., cargo truck, trailer), the antenna panel, if flexible, being adapted to bend about a first axis when an object passes through the entrance or, if rigid, rotate about a hinge connection when an object passes through the entrance.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a schematic illustration of a typical RFID system;

FIG. 2 is a perspective view of one embodiment of the flexible RFID antenna system, according to the invention;

FIG. 3 is a front plan view of the RFID antenna system shown in FIG. 2;

FIG. 4 is an exploded perspective view of one embodiment of the flexible RFID antenna panel, according to the invention;

FIG. 5 is a partial section view of the antenna panel shown in FIG. 4;

FIG. 6 is a perspective view of a further embodiment of a RFID antenna system employing two flexible antenna panels, according to the invention;

FIG. 7 is a front plan view of the RFID antenna system shown in FIG. 6;

FIG. 8 is a perspective view of a further embodiment of a RFID antenna system employing two RFID antenna subsystems, according to the invention;

FIG. 9 is a schematic illustration of a flexible RFID antenna system incorporated into a building entrance, according to the invention;

FIG. 10 is a schematic illustration of a flexible RFID antenna system retrofitted into a trailer, according to the invention; and

FIG. 11 is a schematic illustration of a flexible RFID antenna system retrofitted into a cargo truck, according to the invention.

### DETAILED DESCRIPTION OF THE INVENTION

The RFID antenna of the present invention substantially reduces or eliminates the disadvantages and shortcomings associated with prior art antenna systems. According to one embodiment of the invention, a flexible antenna panel is disposed proximate the interrogation path for interrogating transponders disposed on objects moving along the interrogation path. The antenna panel is preferably oriented such that the plane defined the antenna panel intersects the interrogation path. As discussed in detail below, the antenna panel is further adapted to bend about at least a first axis when an object (with a transponder thereon) intersects the plane defined by the panel.

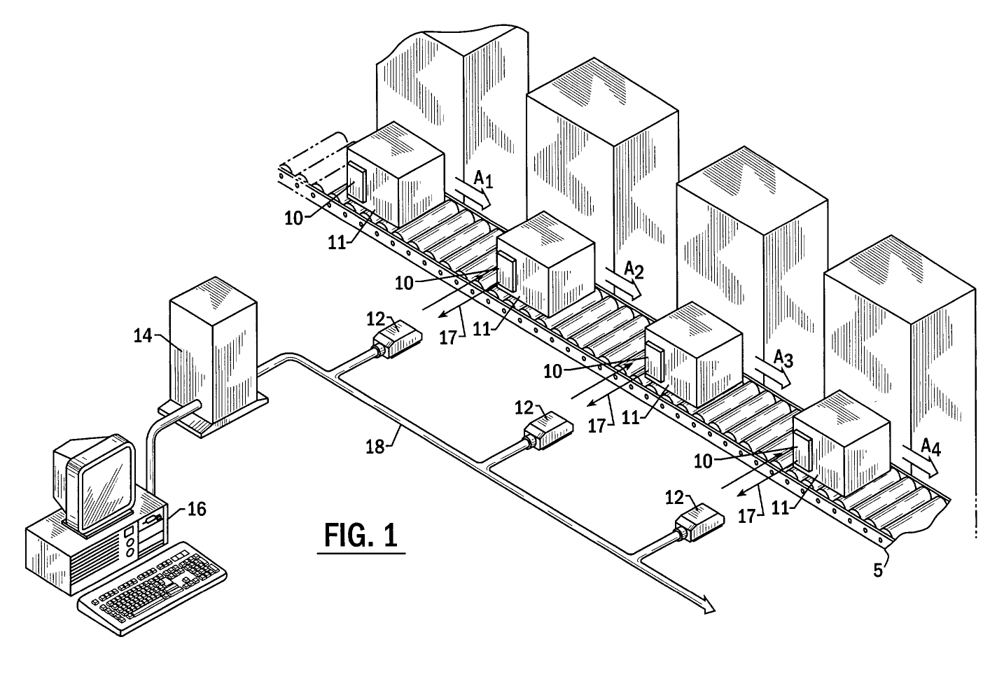

Referring first to FIG. 1, there is shown a simple read/write RFID system. The system typically comprises one or more transponder or tags 10, at least one antenna 12 to communicate with the tags 10, and a controller 14 for managing the communications interface. The host system (i.e., computer) 16 interfaces with the controller 14 and directs the interrogation of the tags 10 disposed on or embedded in the product carriers 11 and any following action via parallel, serial or bus communications 18.

As illustrated in FIG. 1, each antenna 12 is disposed on one side of the interrogation path, denoted by Arrows A₁-A₄, which is defined by the conveyor 5. As such, the RF link 17 and, hence, active RF zone is limited. By the term “active RF zone”, as used herein, it is meant to mean the zone defined by the effective RF radiation or electromagnetic field component.

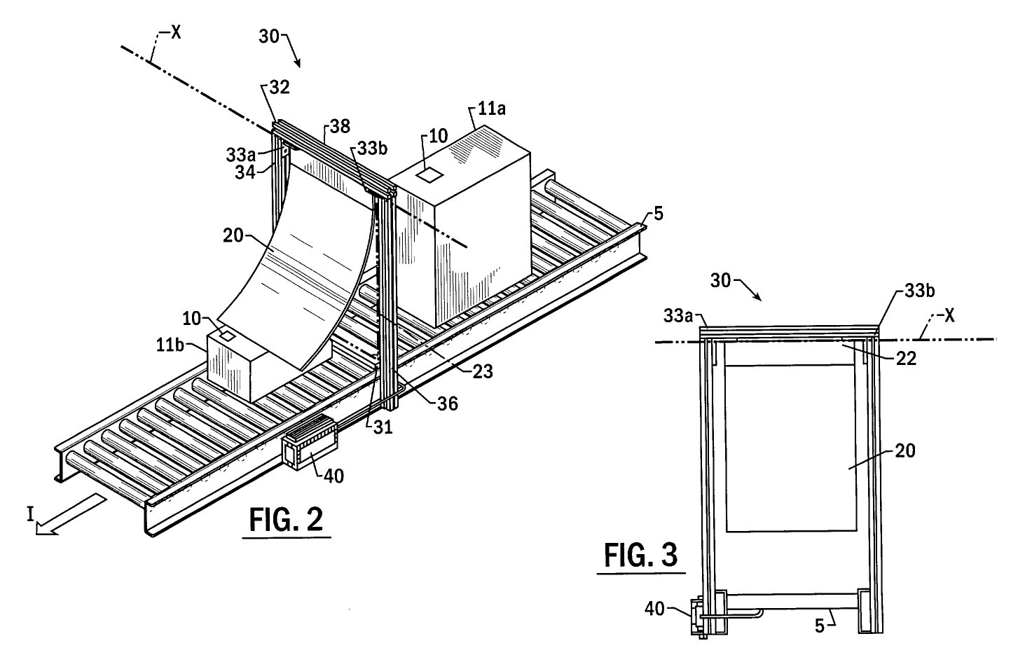

Referring now to FIGS. 2 and 3, there is shown one embodiment of the RFID antenna system 30 of the invention. A key feature of the present invention is the capability of the antenna system 30 to be positioned proximate to or incorporated into a conveyor system 5. As illustrated in FIG. 2, in one embodiment of the invention the antenna system 30 is disposed proximate the interrogation path of the conveyor system 5, denoted by Arrow I, for interrogating the tags 10 and, hence, products or product carriers 1la, 1lb, moving along the interrogation path. As will be appreciated by one having ordinary skill in the art and discussed herein, the antenna panels of the invention can also be secured (hingedly or rigidly) to a ceiling above the interrogation path.

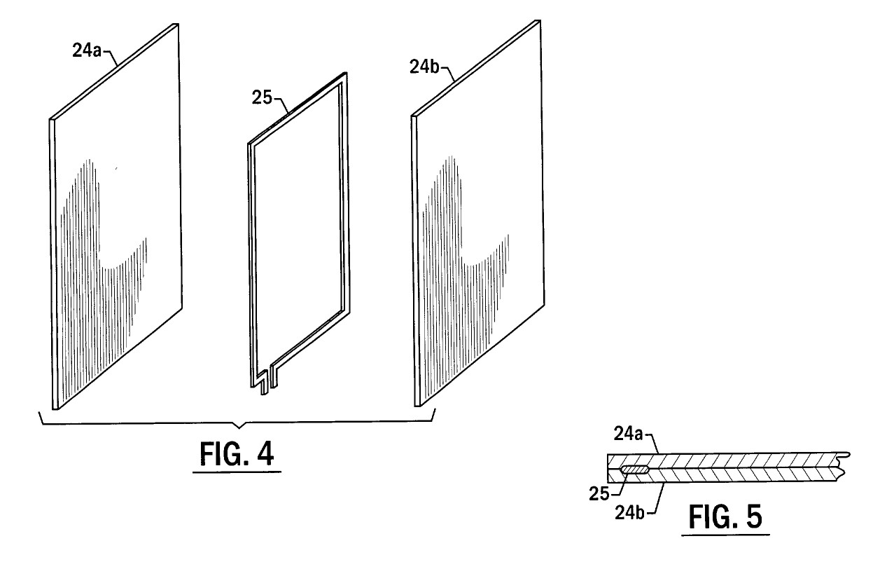

Referring now to FIG. 2, in one embodiment, the antenna system 30 includes (i) a conveyor system 5 adapted to move the product carriers 11a, 11b (or products) with tags 10 disposed thereon along the interrogation path (denoted by Arrow I) that is, in this instance, defined by the conveyor system 5, (ii) an antenna support 32 having at least first and second side supports 34, 36 and a top member 38 attachable to the side supports 34, 36, (iii) at least one antenna panel 20 having at least one antenna loop 25 (see FIG. 4) adapted to transmit and receive electromagnetic fields (i.e., provide an active RF zone), and (iv) an antenna head assembly (i.e., reader/writer) 40.

According to the invention, the antenna panel 20 can be constructed of substantially rigid or flexible material. In a preferred embodiment of the invention, the antenna panel 20 is substantially flexible.

As further illustrated in FIG. 2, the antenna system 30 can, if desired, include a RFID conveyor antenna 31 to further enhance the active RF zone provided by the system 30. Details of the noted RFID conveyor antenna are set forth in U.S. Pat. No. 5,929,760, which is incorporated by reference herein.

As discussed in detail in U.S Pat. No. 5,929,760, the conveyor antenna 31 is preferably disposed proximate an interrogation path and is positioned (and adapted) to transmit and receive electromagnetic fields (and, hence provide a further active RF zone) that intersect the interrogation path. Preferably, the electromagnetic fields provided by the conveyor antenna 31 substantially intersect the interrogation path.

Referring now to FIG. 3, the antenna support 32 includes at least one, preferably two antenna panel connectors 33a, 33b adapted to engage and connect the top portion 22 of the flexible antenna panel 20 to the top antenna support member 38 such that (i) the plane defined by the panel 20 (shown in phantom and denoted 23) intersects the interrogation path (and, hence, defines an antenna region) and (ii) the flexible antenna panel 20 is allowed to bend about at least one panel axis (denoted X) disposed proximate the top portion 22 thereof when a product carrier 11a, 11b (or product) intersects the plane 23 (or antenna region) defined by the panel 20. In a preferred embodiment, the antenna panel 20 is disposed substantially perpendicular to and intersects the interrogation path.

As illustrated in FIG. 2, by virtue of the flexible material employed to construct the panel 20 (discussed in detail below), the panel 20 is also adapted to bend about its body to accommodate a multitude of different size and shape product carriers 11a, 11b (and products).

According to the invention, the antenna support 32 can comprise various lightweight materials, such acrylonitrile butadiene-styrene (ABS), polycarbonate, or polyvinyl chloride (PVC). The support 32 material must, however, provide minimal interference and/or restriction of the antenna RF radiation or electromagnetic field.

In an additional envisioned embodiment of the invention, not shown, the panel connectors comprise conventional hinge connectors that are adapted to hingedly engage the antenna panel 20. In this embodiment, the antenna panels 20 can be either substantially flexible or rigid, preferably, substantially rigid, and would rotate (i.e., swing open) when a product carrier (e.g., 11a) intersects the plane defined by the panel 20.

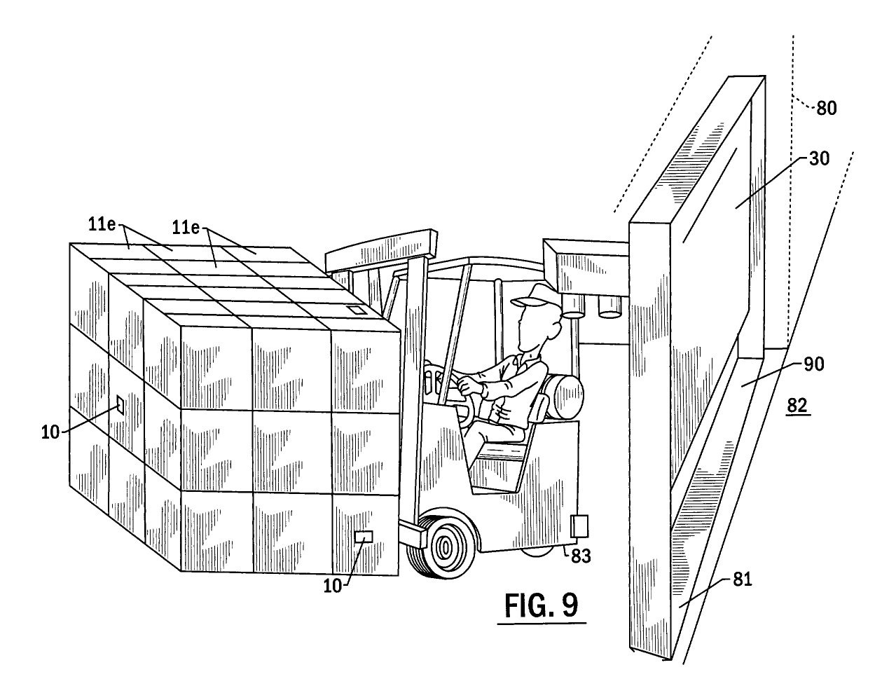

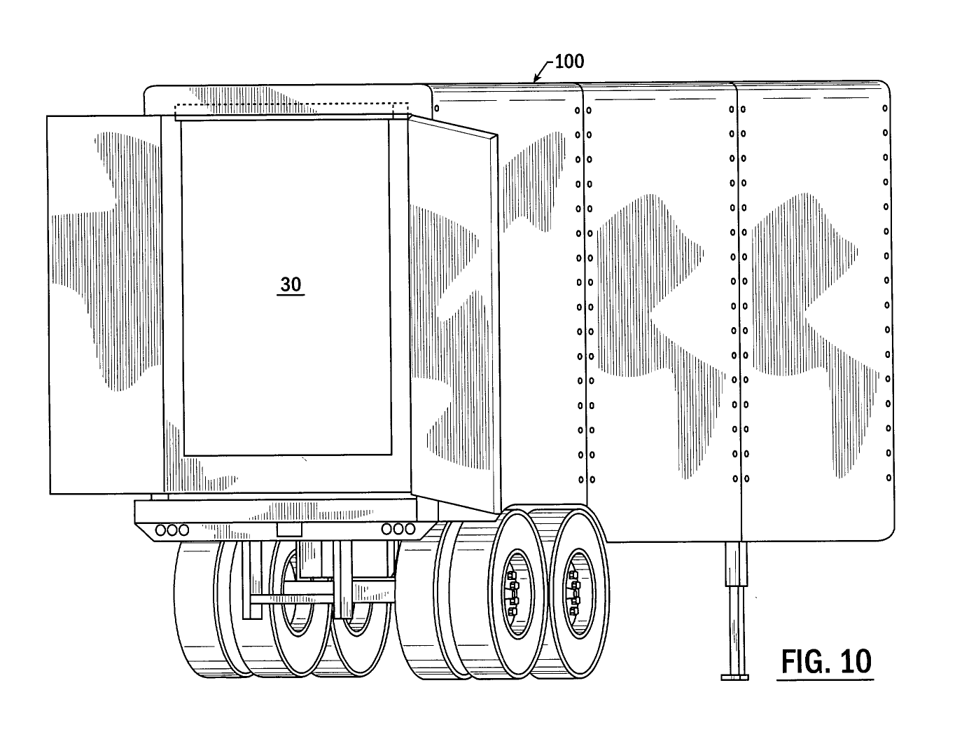

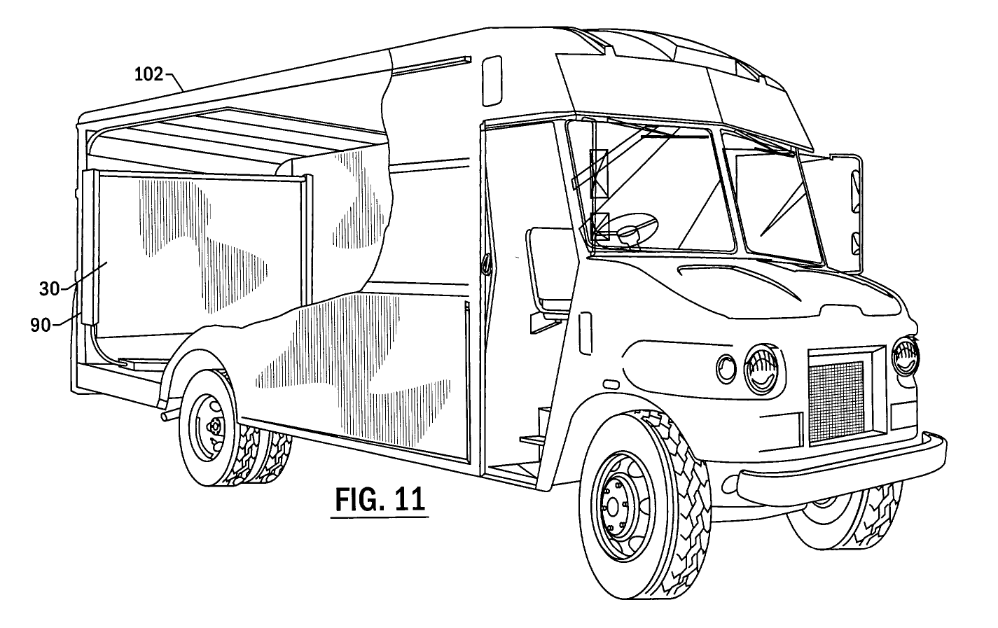

As will be appreciated by one having ordinary skill in the art, the hinge connectors can be attached to an antenna support, such as support member 38 shown in FIG. 2, the ceiling above the conveyor system 5, the top of an entrance to a building (e.g., header), such as illustrated in FIG. 9, or the top of the entrance (or ceiling) of a transport vehicle, such as the cargo truck and trailer illustrated in FIGS. 10 and 11.

Referring back to FIG. 2, the antenna head assembly 40, which includes the antenna logic and associated circuitry for the antenna system 30, is operatively connected to the antenna panel 20 and conveyor antenna 31. Preferably, the head assembly 40 comprises a LRP820 Reader/Writer. The noted device is manufactured and distributed by Escort Memory Systems, Scotts Valley, Calif.

In one embodiment of the invention, the antenna panel 20 and conveyor antenna 31 are designed and adapted to provide 100-ohms of impedance and are connected in parallel to achieve a 50-ohm load. In an alternative embodiment, a power splitter is employed.

Because of the close proximity that the antenna system 30 provides, read range is not critical and a smaller tag 10 can be used. Single or multiple tag commands can thus be sent to the head assembly 40 and both antennas 20, 31 will read either the tag 10 placed on the top of the carrier or carriers 11a, 11b or a tag placed on the bottom (not shown).

As will be appreciated by one having ordinary skill in the art, since the RFID antenna systems of the present invention include all the circuitry necessary to convert the digital signals received from a controller to high speed RF signals for the transponder tags, and conversely to convert the RF signals from the tags back into digital signals for the controller, numerous controllers can be employed with the antenna panel 20 and conveyor antenna 31.

Referring now to FIGS. 4 and 5, the flexible antenna panel 20 of the invention will be described in detail. Referring first to FIG. 4, in one embodiment of the invention, the panel 20 includes first and second substantially flexible panel members 24a, 24b and at least one antenna loop (or circuit) 25. In a further embodiment of the invention, the panel members 24a, 24b are constructed of a substantially rigid material. According to the invention, the antenna loop 25 is adapted to provide an effective RF zone, more preferably transmit at least a first electromagnetic field and receive at least a second electromagnetic field.

Referring to FIG. 5, in one embodiment, the panel members 24a, 24b are substantially planar and are preferably laminated together by conventional means with the antenna loop 25 disposed therebetween. In additional envisioned embodiments, one panel member (e.g., 24a) having at least one antenna loop or circuit disposed on at least one surface thereof is employed.

As will be appreciated by one having ordinary skill in the art, the panel members 24a, 24b can comprise various shapes (e.g., square, oblong, semi-circular, etc.) and dimensions, and be constructed of various flexible or rigid materials. Preferably, the panel members 24a, 24b are substantially planar, substantially rectangular in shape and constructed of commercial grade Neoprene™.

It will be further appreciated by one having skill in the art, that the panel member(s) material and thickness thereof should be selected to provide the least resistance to the product carrier's movement along the interrogation path.

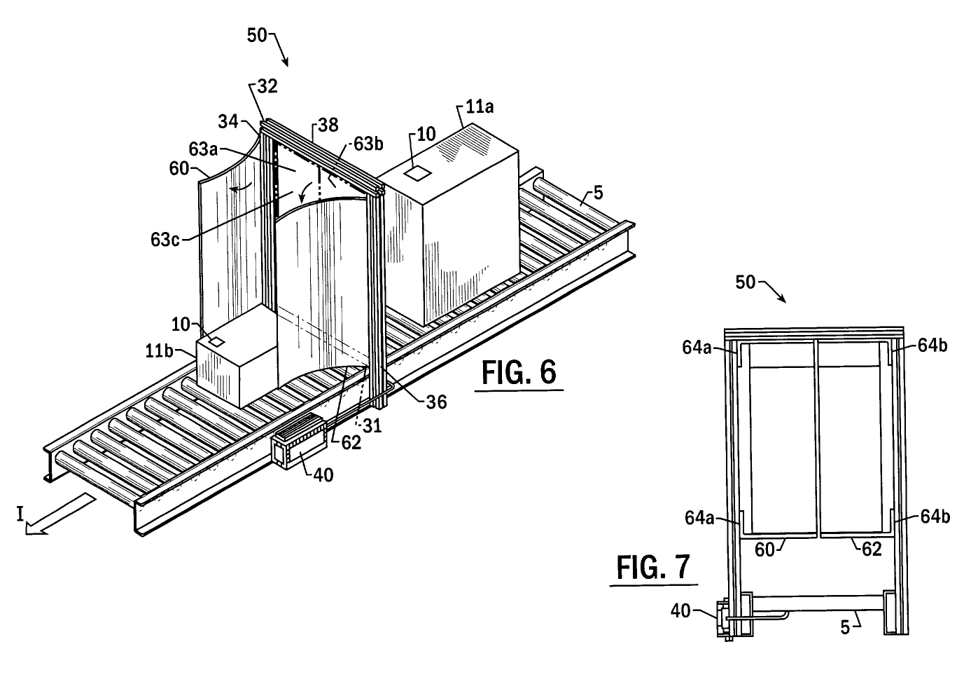

Referring now to FIGS. 6 and 7, there is shown an additional embodiment of the antenna system, designated 50. In the noted embodiment, at least two flexible antenna panels 60, 62 and, if desired, the antenna conveyor 31 are employed.

In one embodiment of the invention, each panel 60, 62 is hingedly connected to the first and second side supports 34, 36 by conventional means. The panels 60, 62 are preferably oriented such that the planes defined by the panels 60, 62 (shown in phantom and designated 63a, 63b, respectively) are substantially perpendicular to and preferably intersect the interrogation path. In a preferred embodiment of the invention, the planes 63a, 63b are substantially coincident and, hence, define an antenna region 63c.

As illustrated in FIG. 6, the antenna panels 60, 62 are further adapted to rotate about the hinge connections 64a, 64b when a product carrier 11a, 11b or product intersects the planes 63a and 63b defined by the panels 60, 62. As will be appreciated by one having ordinary skill in the art, in the noted “hinge connection” embodiment, the panel members 24a, 24b shown in FIG. 4 can be constructed of a substantially flexible material or a substantially rigid material, such as ABS.

According to the invention, each hinge connection 64a, 64b includes conventional biasing means to provide an adjustable closing force (or moment) to the hinge connections 64a, 64b and, hence, panels 60, 62.

In an additional envisioned embodiment (not shown), the panels 60, 62 are rigidly connected to the side supports 34, 36 via panel connectors similar to the panel connectors 33a, 33b shown in FIG. 2. In this embodiment, the antenna panels 60, 62 would be constructed of a substantially flexible material and, hence, bend upon contact with a product carrier or carriers (e.g., 11a, 11b) providing a path therebetween.

In a further envisioned embodiment of the invention (not shown), the antenna system 50 shown in FIG. 6, includes an upper panel, such as antenna panel 20 shown in FIG. 2. According to the invention, the upper antenna panel can be substantially flexible or rigid. In this embodiment, the upper antenna panel would similarly be connected to the top antenna support member 38 or ceiling above the antenna system 5 and adapted to bend or rotate (depending on the antenna panel material) open upon contact with a product carrier (e.g., 11a).

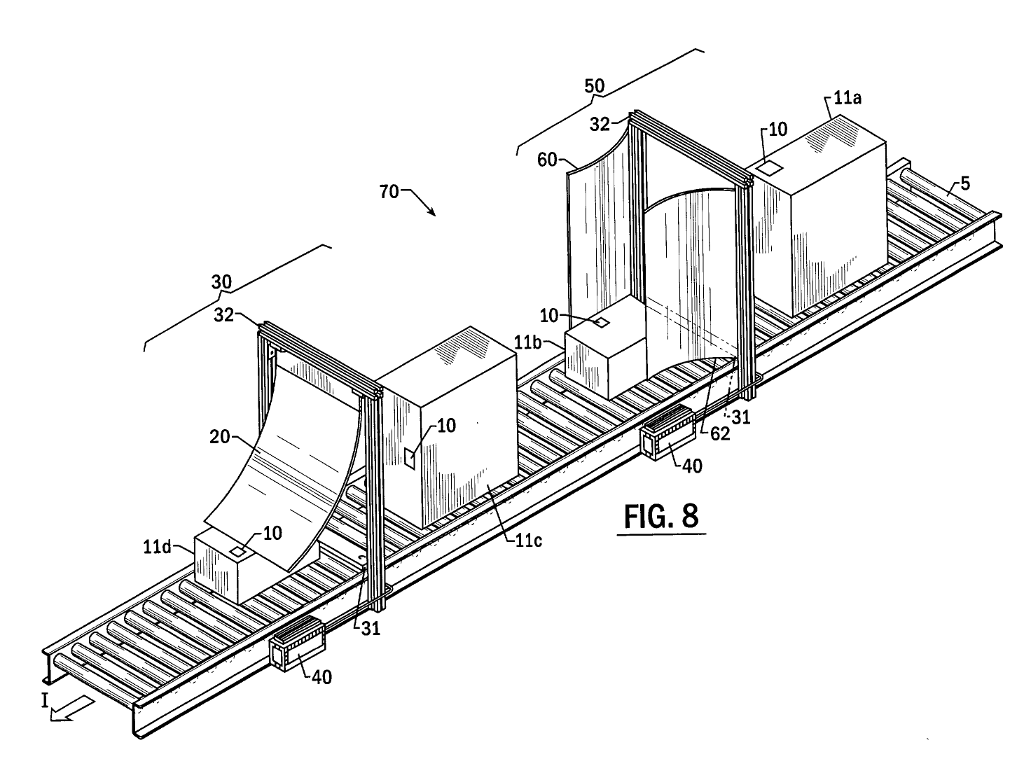

Referring now to FIG. 8, there is shown yet another embodiment of the RFID antenna system 70 of the invention. As illustrated in FIG. 8, the antenna system 70 employs the single and dual panel antenna systems 30, 50, as described above.

According to the invention, the antenna systems 30, 50 can be disposed on or incorporated into the conveyor system 5 in any order, proximate to each other or at a substantial distance apart. Further, a single antenna head assembly 40 or multiple head assemblies can be employed.

Referring now to FIG. 9, there is shown yet another embodiment of the invention wherein the antenna system 30 of the invention is disposed proximate the entrance 81 to a building or warehouse 80. As will be appreciated by one having ordinary skill in the art, the illustrated antenna system 30 ensures that a RFID tagged carriers 11e and/or items will be interrogated and tracked whenever they leave or enter the building 80. The system 30 also facilitates tracking of RFID tagged carriers 11e and items when they are stored on a loading dock 82, for example, prior to warehousing or loading onto a transport device 83.

Alternatively, antenna system 50 shown in FIGS. 6 and 7 can be incorporated into the building entrance 81. Antenna system 50 would similarly facilitate tracking of tagged carriers 11e and items that are transported through the building entrance 81.

The antenna systems 30, 50 can also be employed with a modular RFID antenna system 90 disposed at the building entrance 81 to enhance the active RF zone. Details of the modular antenna system 90 are set forth in Co-Pending application Ser. No. 09/925,129, filed Aug. 8, 2001, which is incorporated by reference herein.

Referring now to FIG. 10, there is shown an additional embodiment of the invention wherein the RFID antenna system 30 of the invention is retrofitted into a trailer 100. In a preferred embodiment, the antenna system 30 includes a modular antenna system 90 that are powered by external battery (not shown). In an additional envisioned embodiment of the invention, the antenna systems 30, 90 are powered by the electrical or battery system of the tractor-trailer.

Referring now to FIG. 11, the RFID antenna system 30 of the invention can also be retrofitted into a cargo truck 102, with a modular antenna system 90 or without. In this embodiment, the antenna system 30 is preferably powered by an existing vehicle battery.

In the embodiments shown in FIGS. 10 and 11, the antenna system 30 communicates with tagged items (product carriers 11, products, etc.) as they are loaded to and unloaded from the trailer 100 or truck 102, allowing accurate tracking of the tagged items throughout the transport chain. In addition to trailers or trucks, the system can be used with any suitable transport vehicle.

While preferred embodiments and their technical advantages have been described in the above detailed description and illustrated in the drawings, the present invention is not limited thereto but only by the scope and spirit of the appended claims.

What is claimed is:

1. A RFID antenna system for communicating with at least one transponder disposed on an object moveable along an interrogation path, comprising:
at least one flexible antenna panel, said antenna panel defining an antenna region, said antenna panel including at least one substantially continuous antenna loop for transmitting and receiving electromagnetic fields,
said antenna panel being oriented such that said antenna panel intersects said interrogation path,
said antenna panel being adapted to bend about at least a first axis when said object intersects said antenna region.

2. The antenna system of claim 1, wherein said antenna panel is disposed substantially perpendicular to said interrogation path.

3. The antenna system of claim 1, wherein said antenna panel is substantially planar.

4. The antenna system of claim 1, wherein said antenna panel is substantially rectangular in shape.

5. The antenna system of claim 4, wherein said antenna panel includes a substantially continuous edge region.

6. The antenna system of claim 5, wherein said antenna loop is disposed proximate said edge region.

7. The antenna system of claim 1, wherein said antenna panel is constructed of Neoprene™.

8. A RFID antenna system for communicating with at least one transponder disposed on an object moveable along an interrogation path, comprising:
at least one substantially rigid antenna panel, said antenna panel defining an antenna region, said antenna panel including at least one substantially continuous antenna loop for transmitting and receiving electromagnetic fields,
said antenna panel being oriented such that said antenna panel intersects said interrogation path,
said antenna panel being hingedly connected to at least a first hinge connector whereby said antenna panel rotates about said hinge connection when said object intersects said antenna region.

9. The antenna system of claim 8, wherein said antenna panel is disposed substantially perpendicular to said interrogation path.

10. The antenna system of claim 8, wherein said antenna panel is substantially planar.

11. The antenna system of claim 8, wherein said antenna panel is substantially rectangular in shape.

12. The antenna system of claim 11, wherein said antenna panel includes a substantially continuous edge region.

13. The antenna system of claim 12, wherein said antenna loop is disposed proximate said edge region.

14. A RFID antenna system for communicating with at least one transponder disposed on an object moveable along an interrogation path, comprising:
a support member;
at least one antenna panel, said antenna panel defining an antenna region, said antenna panel including at least one substantially continuous antenna loop for transmitting at least a first electromagnetic field and receiving at least a second electromagnetic field, said antenna panel being attached to said support member such that said antenna panel intersects said interrogation path; and
control means in communication with said antenna loop for controlling said transmittal and receipt of said first and second electromagnetic fields by said antenna loop.

15. The antenna system of claim 14, wherein said antenna system includes a conveyor system adapted to transport at least one of said objects along said interrogation path.

16. The antenna system of claim 14, wherein said antenna panel is disposed substantially perpendicular to said interrogation path.

17. The antenna system of claim 14, wherein said antenna panel is substantially flexible.

18. The antenna system of claim 17, wherein said antenna panel is substantially planar.

19. The antenna system of claim 17, wherein said antenna panel is substantially rectangular in shape.

20. The antenna system of claim 17, wherein said antenna panel is adapted to bend about at least a first axis when said object intersects said antenna region.

21. The antenna system of claim 14, wherein said support member includes at least one hinge connection, said hinge connection being adapted to hingedly engage said antenna panel.

22. The antenna system of claim 21, wherein said antenna panel is substantially rigid.

23. The antenna system of claim 22, wherein said antenna panel is substantially planar.

24. The antenna system of claim 22, wherein said antenna panel is substantially rectangular in shape.

25. The antenna system of claim 22, wherein said antenna panel is adapted to rotate about said hinge connection when said object intersects said antenna region.

26. The antenna system of claim 14, wherein said antenna system includes a conveyor antenna disposed proximate said interrogation path, said conveyor antenna being adapted to transmit at least a third electromagnetic field and receive at least a fourth electromagnetic field, said third and fourth electromagnetic fields intersecting said interrogation path.

27. A RFID antenna system for communicating with at least one transponder disposed on an object moveable along an interrogation path, comprising:
a support system having a first substantially vertical support member and a second substantially vertical support member;
first and second antenna panels, said first antenna panel including at least a first substantially continuous antenna loop for transmitting at least a first electromagnetic field and receiving at least a second electromagnetic field, said second antenna panel including at least a second substantially continuous antenna loop for transmitting at least a third electromagnetic field and receiving at least a fourth electromagnetic field;
said first and second antenna panels being substantially rectangular in shape and including first and second vertical edge regions,
said first antenna panel first vertical region being engaged to said first vertical support member and said second antenna first vertical region being engaged to said second vertical support member, whereby said first and second antenna panels define an antenna region,
said antenna region intersecting said interrogation path.

28. The antenna system of claim 27, wherein said first and second antenna panels are substantially flexible.

29. The antenna system of claim 27, wherein said first and second antenna panels are substantially rigid.

30. The antenna system of claim 28, wherein said first antenna panel is rigidly engaged to said first vertical support member and said second antenna panel is rigidly engaged to said second vertical support member.

31. The antenna system of claim 30, wherein said first antenna panel is adapted to bend about at least a first axis when said object intersects said antenna region and said second antenna panel is adapted to bend about at least a second axis when said object intersects said antenna region.

32. The antenna system of claim 31, wherein said second axis is substantially parallel to said first axis.

33. The antenna system of claim 29, wherein said first antenna panel is hingedly engaged to said first vertical support member and said second antenna panel is hingedly engaged to said second vertical support member.

34. The antenna system of claim 27, wherein said first and second antenna panels are oriented such that said first antenna panel second vertical region is disposed proximate said second panel second vertical region and is substantially parallel thereto.

35. The antenna system of claim 27, wherein said antenna system includes control means in communication with said first and second antenna loops for controlling said transmittal and receipt of said first, second, third and fourth electromagnetic fields.

36. The antenna system of claim 27, wherein said antenna system includes a conveyor system adapted to transport at least one of said objects along said interrogation path.

37. The antenna system of claim 27, wherein said antenna system includes a conveyor antenna disposed proximate said interrogation path, said conveyor antenna being adapted to transmit at least a fifth electromagnetic field and receive at least a sixth electromagnetic field, said fifth and sixth electromagnetic fields intersecting said interrogation path.
